(19) United States
(12) Patent Application Publication
(10) Pub. No.: US 2010/0189426 A1
(43) Pub. Date: Jul. 29, 2010

(54) SYSTEM AND METHOD FOR HUMAN MACHINE INTERFACE FOR ZOOM CONTENT ON DISPLAY

(75) Inventors: Fu Bao, Shanghai (CN); Ye Guo, Shanghai (CN); Shih-Kuang Tsai, Shanghai (CN)

Correspondence Address: MCDERMOTT WILL & EMERY LLP, 600 13TH STREET, N.W., WASHINGTON, DC, 20005-3096, US

(73) Assignees: INVENTEC APPLIANCES (SHANGHAI) CO., LTD.; INVENTEC APPLIANCES CORP.

(21) Appl. No.: 12/560,542

(22) Filed: Sep. 16, 2009

(30) Foreign Application Priority Data
Jan. 23, 2009 (CN) 200910045886.0

(51) Int. Cl. G03B 17/00

(52) U.S. Cl. 396/77

(57) ABSTRACT

A method and system for automatic zoom adjustment is disclosed. Content is displayed on a display screen for a user. In an auto-zoom mode, a first and a second pictures are acquired. Pre-determined features are detected from the first and second pictures. A first and a second feature distances are computed based on the pre-determined features detected from the first and second pictures, respectively. The first and second feature distances relate to the user's head movement relative to the display screen. An adjustment to the zoom of the content on display is determined based on the difference between the first and the second feature distances.

### BACKGROUND

1. Technical Field

The present teaching relates generally to human machine interface. More specifically, the present teaching relates to automatic zoom control on a hand held device and system and method incorporating the same.

2. Discussion of Related Art

With the advancement of technologies, modern electronic devices are capable of a diversified range of capabilities. For example, an electronic device on the market today is often capable of telephonic communication, electronic mail communications, Internet browsing, and picture or video acquisition, display, and transmission. Due to the limitation of real estate size on the device, especially on hand held devices, content has to be displayed on a display screen in the confine of certain number of pixels in each dimension. In some situations, content displayed has to be zoomed in or out in order to fit different needs.

There are different conventional ways to enable a user to zoom in or out of content on display. On a personal computer or a laptop, a common way to zoom is to first click on a zoom functional button first and then select a region covering a part of the content to be zoomed. On most hand held devices such as Feature Phone, Symbian OS, UIQ, Windows Mobile, or Palm OS, zoom is performed in a substantially similar manner. These devices require two separate steps for each zoom operation. On some cameras, a user may manipulate a mechanical handle to control the zoom of a displayed picture. This requires such cameras to have physical handles made on the camera in order to have manual zoom capability.

There are some improvement on some new devices such as iPhone. A user can use finger to manipulate the touch screen to achieve zoom in and out of the displayed content. For instance, using fingers of one hand, a user can move the fingers in certain way, e.g., move different fingers inward towards each other or outward from each other, to enlarge (zoom in) or shrink (zoom out) the content displayed. However, using such an approach, a user has to use both hands to zoom the content displayed, one hand holding the iPhone the other moves the fingers in a certain manner to control the zoom.

### BRIEF DESCRIPTION OF THE DRAWINGS

The inventions claimed and/or described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1(a) illustrates the scheme of auto zoom control based on user-device distance, according to an embodiment of the present teaching;

FIG. 1(b) depicts the operational process for auto zoom control based on user-device distance, according to an embodiment of the present teaching;

FIGS. 2(a)-2(c) illustrate how user-device distances relate to feature distances detected from pictures, according to an embodiment of the present teaching;

FIGS. 3(a) and 3(b) illustrate exemplary human machine interfaces through which a user can elect to enter into an auto-zoom mode, according to an embodiment of the present teaching;

FIG. 4 is a high level block diagram of an exemplary system capable of adjusting zoom of displayed content automatically in an auto-zoom mode, according to an embodiment of the present teaching; and

FIG. 5 is a flowchart of an exemplary process in which a device operates to automatically adjust zoom of content on display in an auto-zoom mode, according to an embodiment of the present teaching.

### DETAILED DESCRIPTION

The present teaching relates to automatically change the zoom of a displayed picture on a hand held device based on an estimated distance between a user and the hand held device computed in accordance with certain facial features detected from a plurality of pictured of the user.

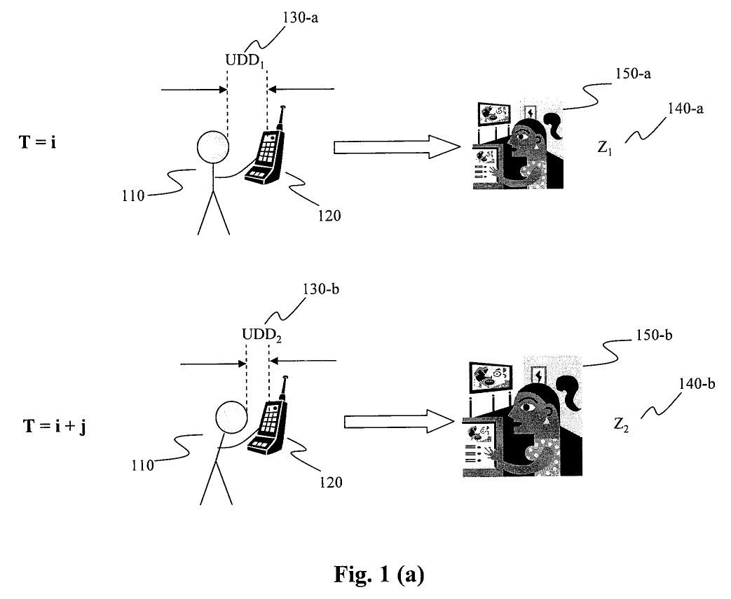

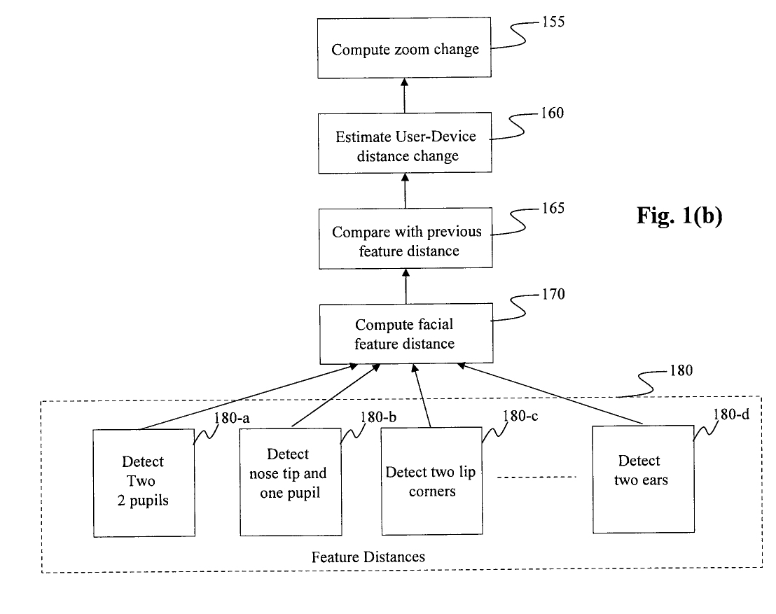

FIG. 1(a) illustrates the scheme 100 of auto zoom control based on user-device distance UDD, according to an embodiment of the present teaching. In this scheme, a user 110 holds a hand held device 120. The distance between the user 110 and the device 120 is measured, e.g., at a particular time, say T=i, between the user's face and the device 120, e.g., UDD, 130-a. A change of such a distance between a user and a hand held device, say at a later time T=i+j, is to be used to adjust the zoom of the content displayed on the hand held device.

It is natural for a user to move his/her head closer to where the content is presented, e.g., on the display screen of the hand held device, in order to see the content more clearly. For example, in FIG. 1, the user 110 may move the head towards the device 120, which yields a smaller distance, e.g., UDD₂ 130-b when compared with the original distance UDD₁ 130-a. The difference between UDD₁ 130-a and UDD₂ 130-b can be used as a basis to make an adjustment to the display of the content 150. In the illustration, the original zoom factor with respect to UDD₁ 130-a is Z₁ 140-a and the effect of applying that zoom factor to the displayed content is 150-a.

When the user 110 moves the head towards the device 120, an adjusted zoom factor Z₂ 140-b can be determined based on UDD₁-UDD₂. When applying the adjusted zoom factor Z₂ 140-b to the content displayed on the hand held device, it produces a different visual effect shown as 150-b, i.e., the content displayed using the zoom factor Z₂ 140-b is zoomed in. Alternatively, if the user 110 moves the head away from the hand held device, the zoom factor can be adjusted to a value so that the content is zoomed out (not shown).

FIG. 1(b) depicts exemplary types of feature distances detected from a picture that can be used for auto zoom control, according to an embodiment of the present teaching. Different features 180 from a picture of a human face (e.g., user's face) may be used to compute some type of feature distance, which may then be used to estimate the user-device distance. As illustrated, exemplary features that may be detected from a picture image include two pupils 180-a, nose and one pupil 180-b, two lip corners 180-c, . . . , and two ears 180-d. Any pair of two features detected from a particular picture of the user may then be used to compute a feature distance, as shown in 170. In some embodiment, one pair of features may be used to compute one distance. In some embodiment, more than one distance may be computed and multiple distances may be used simultaneously to, e.g., improve the robustness or reliability.

A feature distance computed from a picture is usually measured based on the picture arrangement, e.g., number of pixels. For example, a distance between two pupils of a person in the picture may be 98 pixels apart. When the distance between the user 110 and the hand held device 120 changes, the feature distance measure based on the same features in a subsequent picture, e.g., two pupils in a picture acquired 100 ms later, also changes accordingly. Such a change reflects the distance change between the user and the device. For example, when the user's face is closer to the device, the feature distance becomes larger and when the user's face is farther from the device, the feature distance becomes smaller. Therefore, a change in feature distances is done by comparing a currently detected feature distance with a previously detected feature distance, as shown at 165.

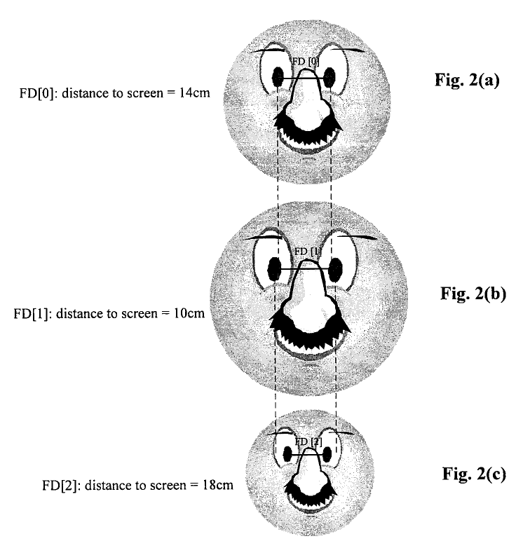

A feature distance may be calibrated against an average distance between two pupils of a person in order to estimate the distance between the user and the hand held device. Alternatively, a feature distance change may also be calibrated against a distance change between a user and a device. Once calibrated, a distance change in features detected from a picture may be used to estimate a change in user-device distance, as shown at 160, and such a change in the user-device distance may then be estimated, as shown at 155. FIGS. 2(a)-2(c) illustrate how user-device distances relate to feature distances detected from pictures.

FIG. 2(a) shows a feature distance FD[0] at a first time instance which corresponds to a user-device distance of 14 cm, estimated between the face of the person and the screen of a device. FIG. 2(b) shows a feature distance FD[1] at a second time instance which corresponds to an estimated user-device distance of 10 cm. FIG. 2(c) shows a feature distance FD[2] at a third time instance which corresponds to an estimated user-device distance of 18 cm.

As shown in FIGS. 2(a)-2(c), according to an exemplary embodiment of the present teaching, the feature distances (e.g., FD[0], FD[1], and FD[3]) relate to the distance between the user's head and the device 120 (shown in FIG. 1). It should be understood that, the features detected from the user's head are for illustrative purposes only, other body parts of the user, such as for example, two shoulders and/or two fingers may also be identified as the features for computing the feature distance, and such features may also facilitate realizing automatic zoom adjustment of the displayed content. As such, the feature distances may relate to the distance between the user and the device 120. The movement of the user with respect to the device 120 (e.g., the movement of the head or other body parts of the user with respect to the device 120) may lead to the change of the distance between the user (e.g., the head or other body parts of the user) and the device 120. Therefore, the feature distances may also relate to the movement of the user with respect to the device 120.

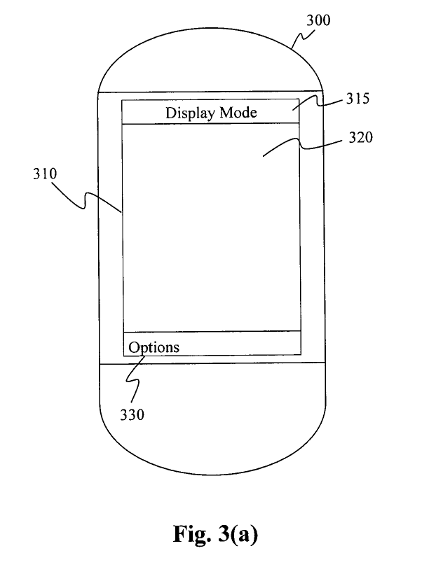

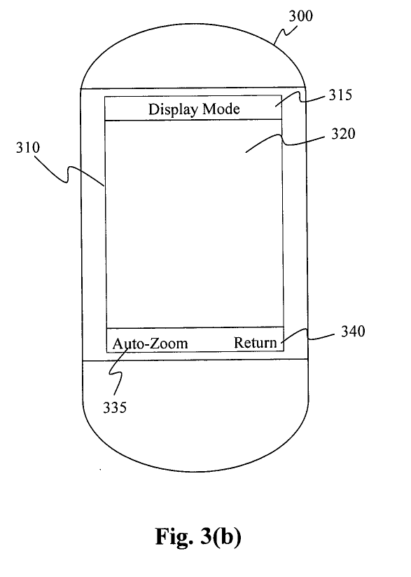

FIG. 3(a) illustrates an exemplary human machine interface through which a user can elect to enter into an auto-zoom mode, according to an embodiment of the present teaching. In this illustration, a hand held device 300 has a display screen 310, on which various human machine interfaces may be shown and different operations may be activated via, e.g., touch screen or clicking soft buttons. One of the human machine interface may be related to display of content, shown as display mode 315. Under this mode, different types of content may be displayed inside of a display area 320. For example, text content, picture content, or content with a mixture of text and picture may be displayed. In some embodiments, under a display mode, a user may be allowed to elect to enter into an auto-zoom mode via a, e.g., soft button 330. With a user's election, the hand held device may then enter into an auto-zoom mode and display as such. This is shown in FIG. 3(b) where an indicator 335 shows that the device is in the auto-zoom mode. An additional “return” button 340 may be provided to allow the user to return to the previous operational mode. In another embodiment, re-clicking the auto-zoom button 335 allows the user to return to the previous operational mode.

Alternatively, the user may keep pressing a predetermined button, such as the auto-zoom button 335 to enter into and continue the auto-zoom mode. A camera (not shown) is then activated in the auto-zoom mode to acquire pictures (described in detail hereinafter). When the user releases the auto-zoom button 335, such as removing the user's finger from the auto-zoom button 335, the auto-zoom mode may be terminated and the hand held device 300 may return to the previous operational mode. In still another embodiment, a hand held device may automatically enter into such a auto-zoom mode whenever there is content displayed without requiring a manual election from the user.

Once entered into the auto-zoom mode, a series of pictures may be acquired by the hand held device via, its built-in camera, from the user and such pictures are then used for computing features distances. For example, in each picture, two eye pupils of the user may be detected and a distance between two pupils in each image may be computed. In another example, the nose and one or two pupils may be detected from such images based on which feature distances may be computed. Any two consecutive user pictures may be acquired based on an interval in time, e.g., every 100 millisecond. Such an interval may be a default in the hand held device or may be set by the user.

Feature distances may be computed either from all the pictures acquired or from some of the pictures acquired. For example, the hand held device may have a default rate for picture acquisition, e.g., every 100 milliseconds, but the auto-zoom function may have an operation parameter set based on which feature distances are computed from pictures separated by two seconds. In this case, changes in feature distances may be estimated every two seconds. Accordingly, the change in user-device distance change is also estimated every two seconds and so is the adjustment to be made to the zoom of the content on display.

Certain measures may be put in place to avoid potentially unpleasant visual effect caused by auto-zoom. For example, if a user happened to move the head back (farther distance from the display screen) and forth (closer to the display screen), if auto-zoom adjust the zoom factor each time when there is a change in user-device distance, the content displayed on the screen of the hand held device may be changing frequently between smaller to larger. To avoid such a problem, some consistency test may be performed by the auto-zoom function to ensure that a detected change in user-device distance has some persistency. For example, a test may be performed to see whether there are consecutive changes in a certain period in which all the changes are towards the same direction, i.e., either closer or further but not back and forth. Then auto-zoom is applied only during those periods where a consistent changes in user-device distance is detected.

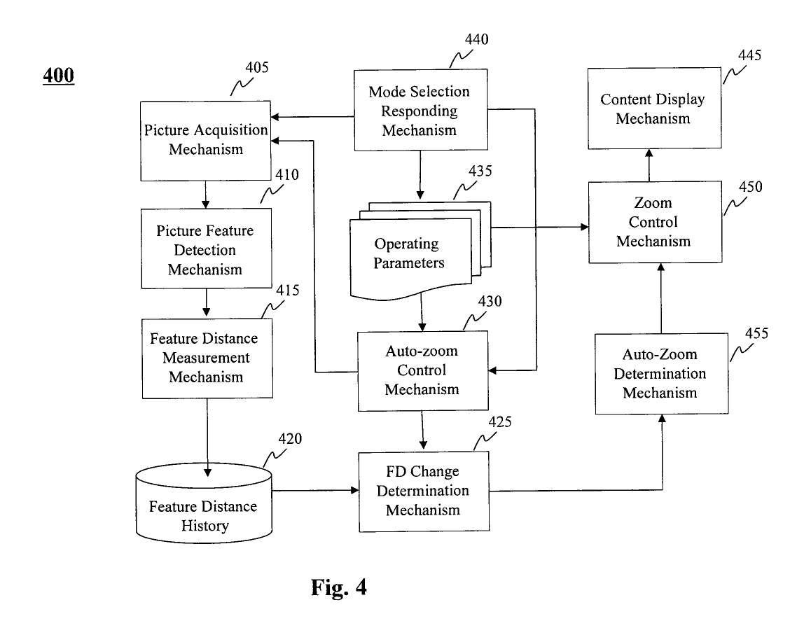

FIG. 4 is a high level block diagram of an exemplary system 400 capable of adjusting zoom of displayed content automatically in an auto-zoom mode, according to an embodiment of the present teaching. The exemplary system 400 comprises a picture acquisition mechanism 405, a picture feature detection mechanism 410, a feature distance measurement mechanism 415, a database 420 storing measured feature distances, a feature distance change determination mechanism 425, an auto-zoom determination mechanism 455, an auto-zoom control mechanism 430, a zoom control mechanism 450, and a content display mechanism 445.

The auto-zoom control mechanism 430 controls various aspects of the auto-zoom capability. Optionally, the exemplary system 400 may also includes an internal file 435 storing various operational parameters. Based on such stored operational parameters in 435, the auto-zoom control mechanism 430 controls the picture acquisition mechanism 405 in terms of, e.g., the rate of picture acquisition. The auto-zoom control mechanism 430 may also control the feature distance change determination mechanism 425, especially when the rate of picture acquisition and the rate of detecting feature distance changes are not the same.

The picture feature detection mechanism 410 process the acquired pictures to extract relevant features, e.g., pupils or nose, and associated information such as the two dimensional coordinates of the detected features. Such extracted information is sent to the feature distance measurement mechanism 415, which computes the features distances based on the received information and stores such computed feature distances into storage 420, where a series of feature distances computed over time is saved for subsequent use. Controlled by the auto-zoom control mechanism 430, the feature distance change determination mechanism 425 retrieve required feature distances from the storage 420 to compute the change in feature distances.

The feature distance change determination mechanism 425 may also have the capability of identifying periods in which changes in feature distance are persistent and ignoring periods in which changes in feature distance are not consistent. Through such filtering, the feature distance change determination mechanism 425 may forward changes that are considered as consistent and robust to the auto-zoom determination mechanism 455, which may then estimate the user-device distance from received feature distance changes and computes an adjustment to be made to the current zoom. Such calculated zoom adjustment is then sent to the zoom control mechanism 450.

The zoom control mechanism 450 may control various aspects regarding how to effectuate a zoom adjustment to the content displayed. There may be different considerations. For instance, zoom adjustment may need to be done in a visually pleasing manner, e.g., using an appropriate center of zoom and apply an appropriate frequency to adjust zoom, etc. Such operational parameters may also be stored in 435. In some embodiments, there is an optional mode selection responding mechanism 440, which responds to user's election of different operational mode and operational parameters. The mode selection responding mechanism 440, once activated, may invoke relevant mechanisms such as the picture acquisition mechanism 405 and the auto-zoom control mechanism 430 and forward user selected operational parameters to storage 435 so that other mechanisms may operate accordingly.

To effectuate the zoom adjustment, if any, the zoom control mechanism 450 interact with the content display mechanism 445, which renders the content in accordance with an adjusted zoom factor, determined by the auto-zoom determination mechanism 455 and in a manner controlled by the zoom control mechanism 450.

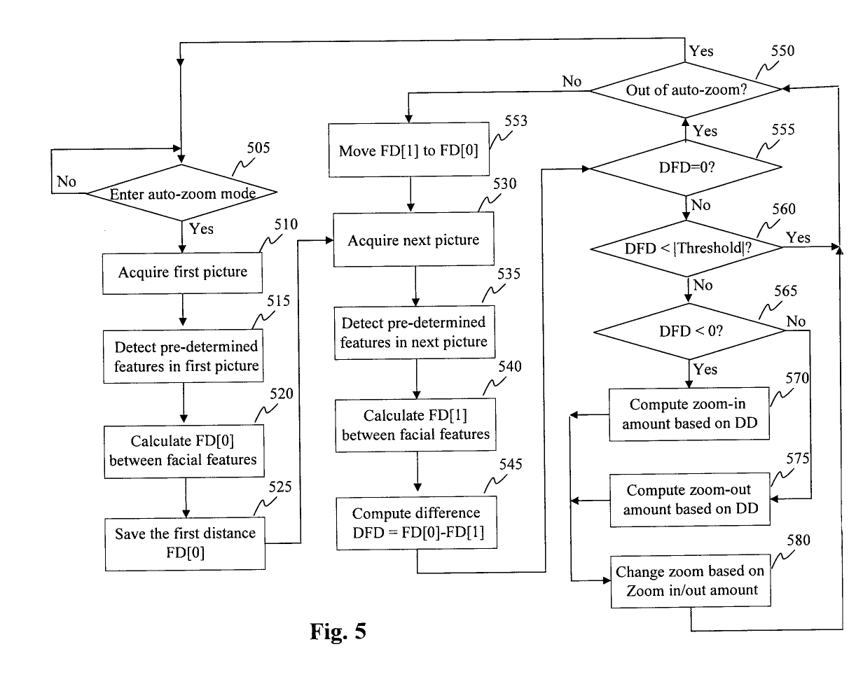

FIG. 5 is a flowchart of an exemplary process in which a device operates to automatically adjust zoom of content on display in an auto-zoom mode, according to an embodiment of the present teaching. It is determined first, at 505, whether the hand held device should enter into an auto-zoom mode. If the device is in the auto-zoom mode, a first picture is acquired at 510. Some pre-determined features, e.g., pupils, are then detected, at 515, from the first picture and a feature distance FD[0] is computed, at 520, based on the detected features and saved at 525. Similar operations for obtaining a second feature distance FD[1] based on a next picture are performed at 530, 535, and 540.

Based on two feature distances, a feature distance change DFD is computed at 545. If DFD is zero, i.e., no change, determined at 555, it is determined, at 550, whether to exit the auto-zoom mode. If it is to exit the auto-zoom mode, the process returns to 505. If it is to remain in the auto-zoom mode, the current feature distance FD[1] is marked as a past feature distance FD[0] at 553 and then returns to 530 to acquire the next picture, to detecting features in the new next picture at 535, and compute the next new feature distance FD[1] at 540.

If the current feature distance change DFD is not zero, determined at 555, it is determined whether the absolute value of DFD or |DFD| is larger than a certain threshold. This is to ensure that a very small change may not be stable or reliable and may need to be ignored. If |DFD| is smaller than the threshold, the processing returns to 550. Otherwise, it is further determined, at 565, whether DFD is greater than zero or less than zero. If DFD is larger than zero, it means that the user moves the head farther from the display screen when DFD=FD[0]−FD[1]. In this case, an adjustment to be made to zoom out the content on display is calculated at 575. Otherwise, an adjustment to be made to zoom in the content on display is calculated at 570. The calculated zoom adjustment is then used, at 580, to apply to the content that is being displayed based on the adjustment automatically determined based on the movement of the user's head.

While the inventions have been described with reference to the certain illustrated embodiments, the words that have been used herein are words of description, rather than words of limitation. Changes may be made, within the purview of the appended claims, without departing from the scope and spirit of the invention in its aspects. Although the inventions have been described herein with reference to particular structures, acts, and materials, the invention is not to be limited to the particulars disclosed, but rather can be embodied in a wide variety of forms, some of which may be quite different from those of the disclosed embodiments, and extends to all equivalent structures, acts, and, materials, such as are within the scope of the appended claims.

We claim:

1. A method for automatic zoom adjustment, comprising:
displaying content on a display screen;
acquiring a first picture of a user;
computing a first feature distance based on a first set of pre-determined features detected from the first picture;
acquiring a second picture of the user;
computing a second feature distance based on a second set of pre-determined features detected from the second picture, wherein the first and second feature distances relate to a movement of the user relative to a hand held device; and
adjusting zoom to the displayed content based on a difference between the first feature distance and the second feature distance.

2. The method according to claim 1, wherein the content displayed on the display screen includes at least one of text and an image.

3. The method according to claim 1, wherein the at least two pre-determined features includes pupils of the user in the acquired pictures.

4. The method according to claim 1, wherein the at least two pre-determined features includes one pupil and one nose of the user in the acquired pictures.

5. The method according to claim 1, wherein the at least two pre-determined features includes two pupils and one nose of the user in the acquired pictures.

6. The method according to claim 1, wherein there is a short delay between the acquisitions of the first picture and the second picture.

7. The method according to claim 1, wherein the adjusting comprises:
computing the difference between the first feature distance and the second feature distance;
zooming-in the content, if the second feature difference is larger than the first feature difference, in accordance with a first amount determined proportional to the difference; and
zooming-out the content, if the second feature difference is smaller than the first feature difference, in accordance with a second amount determined proportional to the difference.

8. The method according to claim 1, further comprising entering into an automatic zoom mode in accordance with an election made by the user prior to the acquiring the first picture.

9. A system for automatic zoom adjustment, comprising:
a content displaying mechanism configured for displaying content on a display screen in accordance with a zoom factor;
a picture acquisition mechanism configured for acquiring a first and a second pictures of a user, wherein the first picture is acquired prior to the second picture;
a picture feature detection mechanism configured for detecting a first set of at least two pre-determined features from the first picture and a second set of the at least two pre-determined features from the second picture;
a feature distance measurement mechanism configured for computing a first feature distance based on the first set of pre-determined features and a second feature distance based on the second set of pre-determined features, wherein the first and second feature distances relate to the distance between of the user relative to the hand held device; and
an auto-zoom determination mechanism capable of computing an adjustment to the zoom factor based on the difference between the first feature distance and the second feature distance.

10. The system according to claim 9, wherein the auto-zoom determination mechanism is further capable of:
computing a difference between the first feature distance and the second feature distance;
zooming-in the content, if the second feature difference is larger than the first feature difference, in accordance with a first amount determined proportional to the difference; and
zooming-out the content, if the second feature difference is smaller than the first feature difference, in accordance with a second amount determined proportional to the difference.

11. The system according to claim 9, further comprising a mode selection responding mechanism configured for interacting with the user to enable the user to elect to enter into a mode for automatic zoom adjustment.

12. The system according to claim 9, wherein the first picture and the second picture is separated by a first time interval.

13. A hand held device capable of automatic zoom adjustment, comprising:
a feature distance measurement mechanism configured for computing a first feature distance based on the first set of pre-determined features and a second feature distance based on the second set of pre-determined features;
a display screen configured for displaying content to a user;
a picture acquisition mechanism configured for acquiring a first and a second pictures of the user;
a feature distance measurement mechanism configured for computing a first feature distance from the first picture and a second feature distance from the second picture, wherein the first and second feature distances relate to a movement of the user's head relative to the hand held device; and
an auto-zoom determination mechanism capable of computing an adjustment to the zoom factor based on the difference between the first feature distance and the second feature distance; and
a content display mechanism capable of adjusting the display of the content on the display screen based on the adjustment to the zoom factor.

14. The hand held device according to claim 13, further comprising a picture feature detection mechanism configured for detecting a first set of at least two pre-determined features from the first picture and a second set of the at least two pre-determined features from the second picture, wherein the first feature distance is computed based on the first set of pre-determined features and the second feature distance is computed based on the second set of pre-determined features.

15. The system according to claim 14, wherein the at least two pre-determined features includes pupils of the user in the acquired pictures.

16. The method according to claim 14, wherein the at least two pre-determined features includes one pupil and one nose of the user in the acquired pictures.
